(19) United States
(12) Patent Application Publication
(10) Pub. No.: US 2023/0339336 A1
(43) Pub. Date: Oct. 26, 2023

(54) SYSTEM AND METHOD WITH A DIRECT CURRENT TO DIRECT CURRENT (DC/DC) PRE-CHARGER

(71) Applicant: Proterra Operating Company, Inc., Burlingame, CA (US)

(72) Inventor: Kurt M. NOLTE, Greenville, SC (US)

(21) Appl. No.: 17/729,544

(22) Filed: Apr. 26, 2022

(51) Int. Cl. B60L 53/10; H02J 7/00; B60L 53/62; H02M 1/36; B60L 3/00; B60L 58/12

(52) U.S. Cl. CPC B60L 53/11; H02J 7/0048; B60L 53/62; H02M 1/36; B60L 3/0046; B60L 58/12; B60L 2270/20; B60L 2210/10

(57) ABSTRACT

A battery system may include a battery pack including a direct current to direct current (DC/DC) pre-charger and a battery cell. The battery pack may include a positive terminal and a negative terminal of the battery cell electrically connected to a first positive bidirectional terminal and a first negative bidirectional terminal, respectively. The positive terminal and the negative terminal may be electrically connected to a positive output terminal and a negative output terminal, respectively, via a positive electrical connection and a negative electrical connection. The battery pack may further include a high voltage bus bar electrically connected to the positive output terminal and the negative output terminal and a communication bus bar electrically connected to the DC/DC pre-charger. The DC/DC pre-charger may pre-charge the high voltage bus bar and/or discharge the high voltage bus bar via a second positive bidirectional terminal and a second negative bidirectional terminal.

### TECHNICAL FIELD

Embodiments of this disclosure relate to a battery system and, more particularly, to a battery system that includes a direct current to direct current (DC/DC) pre-charger.

### BACKGROUND

High voltage (HV) direct current (DC) systems, such as those used for battery electric vehicles, maintain isolation of the battery from the high voltage distribution and devices (e.g., on a HV bus bar) while not in operation. Prior to the start of operations, the voltage on the HV bus bar has to be brought up to within a tolerance of the battery voltage to prevent excessive current flow when the contactors are closed.

The conventional method of accomplishing this task is to use a high-wattage resistor and a contactor to bypass the main battery contactors. Depending on the design, this permits a limited amount of current to pass through and charge up a capacitance in the HV bus bar, thereby preventing the excessive current flow on closure of the battery contactors.

This method may be sufficient when the capacitance of the HV bus bar is known beforehand but can present problems if there are changes to the external configuration or deviations in the resistor, either as a result of damage to the device or manufacturing defects. Additionally, the resistor and contactor arrangement provides protective isolation for the battery system only so long as the contactor itself remains functional and failure of the contactor may result in the pre-charge circuit being in a constant on state, resulting in a loss of isolation between the HV bus bar and the battery system. As such, potentially dangerous DC voltage may be present on the HV bus bar even with the system powered off. Embodiments of the current disclosure may address these limitations and/or other problems in the art.

### SUMMARY

Embodiments of the present disclosure relate to, among other things, battery systems for electric vehicles. Each of the embodiments disclosed herein may include one or more of the features described in connection with any of the other disclosed embodiments.

In one aspect, a battery system may include at least one battery pack including a direct current to direct current (DC/DC) pre-charger and at least one battery cell. The at least one battery pack may include a positive terminal and a negative terminal of the at least one battery cell electrically connected to a first positive bidirectional terminal and a first negative bidirectional terminal, respectively, associated with the DC/DC pre-charger. The positive terminal and the negative terminal may be electrically connected to a positive output terminal and a negative output terminal, respectively, of the at least one battery pack via at least one positive electrical connection and at least one negative electrical connection. The at least one battery pack may further include a high voltage bus bar electrically connected to the positive output terminal and the negative output terminal of the at least one battery pack and a communication bus bar electrically connected to the DC/DC pre-charger. The DC/DC pre-charger may be configured to pre-charge the high voltage bus bar and/or discharge the high voltage bus bar via a second positive bidirectional terminal and a second negative bidirectional terminal.

In another aspect, a method of using a direct current to direct current (DC/DC) pre-charger located within a battery pack of a battery system may be performed. The DC/DC pre-charger may be electrically connected to one or more battery cells of the battery pack. The method may include receiving, by a computing system, a signal to control the DC/DC pre-charger and controlling one or more battery pack contactors or the DC/DC pre-charger based on one or more parameters. The method may further include receiving or reporting data associated with operation of the DC/DC pre-charger while controlling the one or more battery pack contactors and the DC/DC pre-charger.

In yet another aspect, a method of using a direct current to direct current (DC/DC) pre-charger located within a battery pack of a battery system may be performed. The DC/DC pre-charger may be electrically connected to one or more battery cells of the battery pack. The method may include sampling, by a computer system, a voltage on a DC bus bar of the battery system and generating or transmitting limits for an operation of the DC/DC pre-charger. The method may further include receiving data related to the operation of the DC/DC pre-charger and closing one or more battery contactors of the battery pack when the voltage reaches a target voltage.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIGS. 1A and 1B illustrate an exemplary electric bus having a battery system, according to the present disclosure;

FIG. 2 is a schematic illustration of an exemplary battery system of the bus of FIGS. 1A and 1B, according to the present disclosure;

FIG. 3 is a schematic illustration of an exemplary battery module of the battery system of FIG. 2, according to the present disclosure;

FIG. 4 is a schematic illustration of connections between the battery pack of FIG. 2 and peripheral devices or systems of the bus of FIGS. 1A and 1B, according to the present disclosure;

FIG. 5 is a schematic illustration of a first configuration of a battery pack of the battery system of FIG. 2 that includes a DC/DC pre-charger, according to the present disclosure;

FIG. 6 is a schematic illustration of a second configuration of a battery pack of the battery system of FIG. 2 that includes a DC/DC pre-charger, according to the present disclosure;

FIG. 7 is a schematic illustration of a third configuration of a battery pack of the battery system of FIG. 2 that includes a DC/DC pre-charger, according to the present disclosure;

FIG. 8 is a schematic illustration of a junction box that includes a DC/DC pre-charger, according to the present disclosure;

FIG. 9 is a schematic illustration of a string of battery packs of the battery system of FIG. 2, according to the present disclosure;

FIG. 10 is another schematic illustration of a string of battery packs of the battery system of FIG. 2, according to the present disclosure;

FIG. 11 illustrates an exemplary method of controlling pre-charge operations of a DC/DC pre-charger using a battery management system (BMS), according to the present disclosure;

FIG. 12 illustrates an exemplary method of controlling pre-charge operations of a DC/DC pre-charger using an energy storage management (ESM) system, according to the present disclosure;

FIG. 13 illustrates an exemplary method of controlling discharge operations of a DC/DC pre-charger using an energy storage management (ESM) system, according to the present disclosure; and

FIG. 14 illustrates example components of a computing device, according to the present disclosure.

### DETAILED DESCRIPTION

The present disclosure describes a system and method for a battery system including a DC/DC pre-charger. While principles of the current disclosure are described with reference to an electric bus, it should be understood that the disclosure is not limited thereto. Rather, the systems and methods of the present disclosure may be used in any vehicle having a battery system (e.g., electric vehicle, electric machine, electric tool, electric appliance, etc.). As used herein, the term “electric vehicle” includes any vehicle or transport machine that is driven at least in part by electricity (e.g., hybrid vehicles, all-electric vehicles, etc.). Heavy duty electric vehicles (e.g., electric buses, electric trucks, electric airplanes, electric boats, etc.) may store and/or consume a large amount of energy compared to smaller electric vehicles (e.g., electric cars, electric bicycles or motorcycles, electric carts, etc.).

In this disclosure, relative terms, such as “about,” “substantially,” or “approximately” are used to indicate a possible variation of ±10% of a stated value.

Any implementation described herein as exemplary is not to be construed as preferred or advantageous over other implementations. Rather, the term “exemplary” is used in the sense of example or illustrative.

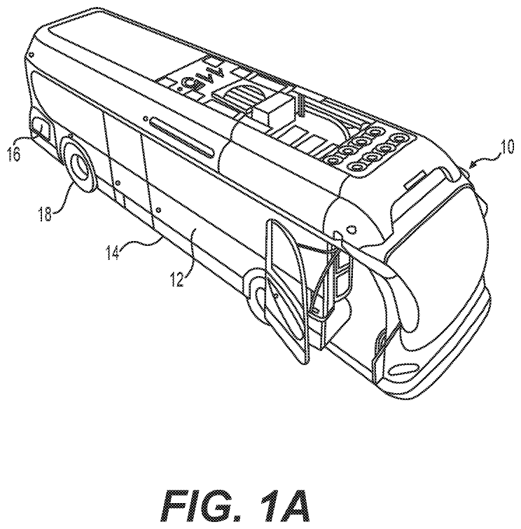

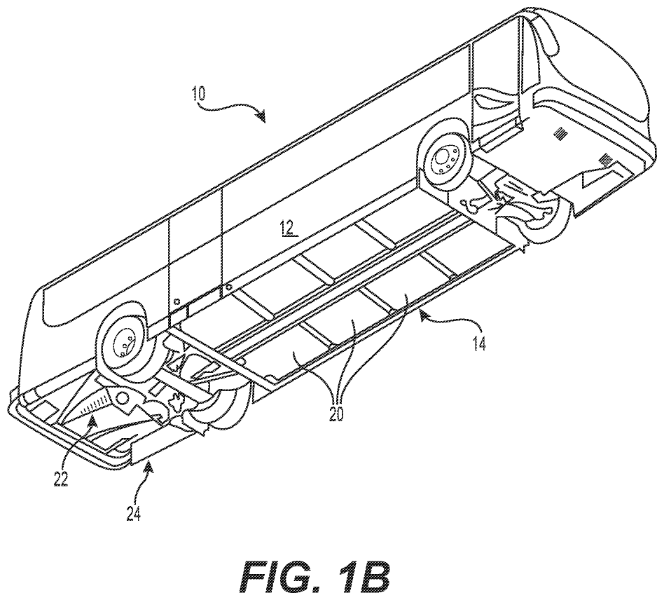

FIGS. 1A and 1B illustrate an electric vehicle in the form of a bus 10. FIG. 1A shows the bus 10 with its roof visible, and FIG. 1B shows the bus 10 with its undercarriage visible. In the discussion below, reference will be made to both FIGS. 1A and 1B. The bus 10 may include a body 12 enclosing a space for passengers. In some embodiments, some (or substantially all) parts of the body 12 may be fabricated using one or more composite materials to reduce the weight of the bus 10. Without limitation, the body 12 of the bus 10 may have any size, shape, and configuration. In some embodiments, the bus 10 may be a low-floor electric bus. In a low-floor electric bus, there may be no stairs at the front and/or the back doors of the bus 10. In such a bus 10, the floor may be positioned close to the road surface to ease entry and exit into the bus 10. In some embodiments, the floor height of the low-floor bus may be about 30-45 centimeters from the road surface.

The bus 10 may include a powertrain 24 that propels the bus 10 along a road surface. The powertrain 24 may include one or more electric motors 22 that generate power, and a transmission that transmits the power to a pair of drive wheels (e.g., wheels 18) of the bus 10. A battery system 14 may store electrical energy to power the electric motors 22 of the powertrain 24. In some embodiments, the batteries of the battery system 14 may be configured as a plurality of battery packs 20 positioned in cavities located under the floor of the bus 10. In some embodiments, some or all of the battery packs 20 may be positioned elsewhere (e.g., roof) on the bus 10. The batteries of the battery system 14 may have any chemistry and construction. The battery chemistry and construction may activate fast charging of the batteries. In some embodiments, the batteries may be lithium titanate oxide (LTO) batteries. In some embodiments, the batteries may be nickel metal cobalt oxide (NMC) batteries. It is also contemplated that, in some embodiments, the batteries may include multiple different chemistries.

The bus 10 may include a charging interface. For example, the bus 10 may include a charge port (e.g., an electric socket) that is configured to receive a charging plug and charge the bus 10 using power from a utility grid. In such embodiments, the bus 10 may be charged by connecting the plug to the socket. In some embodiments, the charge port may be a standardized charge port (e.g., a Society of Automotive Engineers (SAE) J1772 charge port) that is configured to receive a corresponding standardized connector (e.g., a SAE J1772 connector). However, in general, the charge port and the mating connector may be of any type and form (custom design or standardized). As illustrated in FIG. 1A, to protect the charge port from the environment (rain, snow, debris, etc.), a hinged lid 16 may cover the charge port when not in use. Additionally, or alternatively, a charging interface may be provided on the roof of the bus 10 (not illustrated in FIGS. 1A and 1B) to charge the batteries of the battery system 14. For example, the charging interface may include components that interface with a charging head (e.g., an inverted pantograph that interfaces with a set of rails mounted on the forward rooftop of the bus 10) of an external charging station to charge the batteries.

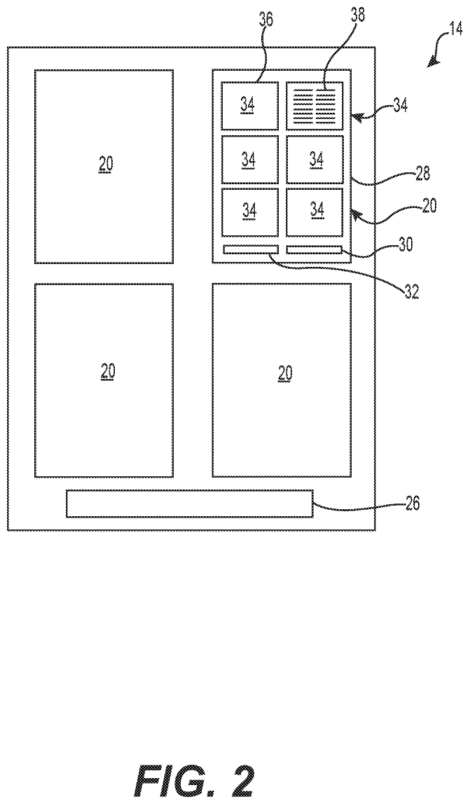

FIG. 2 is a schematic illustration of an exemplary battery system 14 of the bus 10 of FIGS. 1A and 1B, according to the present disclosure. The battery system 14 may include a plurality of battery packs 20. Each battery pack 20 may include a plurality of battery modules 34, and each battery module 34 may include a plurality of battery cells 38 arranged therein. In FIG. 2, the inside structure of one of the battery packs 20, and the inside structure of one of the battery modules 34 of the battery pack 20, are shown to aid in the discussion below. The battery cells 38 may have any chemistry and construction. In some embodiments, the battery cells 38 may have a lithium-ion chemistry. Lithium-ion chemistry comprises a family of battery chemistries that employ various combinations of anode and cathode materials. In automotive applications, these chemistries may include lithium-nickel-cobalt-aluminum (NCA), lithium-nickel-manganese-cobalt (NMC), lithium-manganese-spinel (LMO), lithium titanate (LTO), and lithium-iron phosphate (LFP), for example. In consumer applications, the battery chemistry may also include lithium-cobalt oxide (LCO), for example.

The plurality of battery packs 20 of the battery system 14 may be connected together in series or in parallel. In some embodiments, these battery packs 20 may also be arranged in strings. For example, the battery system 14 may include multiple strings connected in parallel, with each string including multiple battery packs 20 connected together in series. Configuring the battery system 14 as parallel-connected strings may allow the bus 10 to continue operating with one or more strings disconnected if a battery pack 20 in a string fails or experiences a problem. The plurality of battery modules 34 in each battery pack 20, and the plurality of battery cells 38 in each battery module 34, may also be electrically connected together in series or parallel. In some embodiments, some of the battery modules 34 in a battery pack 20 may be connected together in series, and groups of the series-connected battery modules 34 connected together in parallel. Similarly, in some embodiments, a group of battery cells 38 in each battery module 34 may be connected together in series to form multiple series-connected groups of battery cells 38, and these series-connected groups may be connected together in parallel. That is, some or all battery packs 20 in the battery system 14 may include both series-connected and parallel-connected battery modules 34, and some or all battery modules 34 in each battery pack 20 may include both series-connected and parallel-connected battery cells 38. In some embodiments, each battery pack 20 of the battery system 14 may be substantially identical (in terms of number of battery modules 34, number of battery cells 38 in each battery module 34, how the battery modules 34 are connected, etc.) to each other. In other embodiments, one or more of the battery packs 20 of the battery system 14 may have a different configuration than one or more other battery packs 20 of the battery system 14.

In general, the battery packs 20 of the battery system 14 may be physically arranged in any manner. In some embodiments, the battery packs 20 may be arranged in a single layer on a common horizontal plane to decrease the height of the battery system 14, so that it may be positioned under the floor of the low-floor bus 10. For example, the battery packs 20 may have a height less than or equal to about 18 centimeters, to allow the battery system 14 to be accommodated under the floor of the low-floor bus 10. The low height profile of the battery system 14 may allow the battery system 14 to be more aerodynamic, and may increase its surface area relative to the number of battery cells 38, which may increase heat dissipation and improve temperature regulation. In general, the battery system 14 may be configured to store any amount of energy and to export or import electrical power (in terms of Watts (W)) at a voltage (V). Increasing the amount of energy stored in the battery system 14 may increase the distance that the bus 10 can travel between recharges. In some embodiments, the number of the battery packs 20, the battery modules 34, the battery cells 38, and the chemistry of the battery cells 38, etc. may be configured such that the total energy capacity of the battery system 14 may be between, for example, about 200-700 kilowatt hours (KWh).

In general, the battery system 14 may have any number (e.g., 1, 2, 3, 4, 6, 8, 10, etc.) of battery packs 20. In some embodiments, the number of battery packs 20 in the battery system 14 may be between about 2 and 6. Each battery pack 20 may have a protective housing 28 that encloses the plurality of battery modules 34 (and other components of the battery pack 20) therein. Although the battery pack 20 of FIG. 2 is illustrated as including six battery modules 34 arranged in two columns, this is merely an example. In general, any number (e.g., 1, 4, 5, 6, 8, 10, 12, 14, 16, 18, 20, 22, 24, etc.) of battery modules 34 may be provided in a battery pack 20, and each battery module 34 may include any number of battery cells 38 (e.g., 1, 100, 101, 200, 300, 400, 500, 600, 800, etc.) arranged in any manner. In some embodiments, the number of battery modules 34 in each battery pack 20 may be between about 10 and 20, and the number of battery cells 38 housed in each battery module 34 may be between about 400 and 700. In some embodiments, the battery modules 34 housed in the housing 28 of a battery pack 20 may be separated from each other with dividers (not shown) that provide electrical and thermal insulation. The dividers may protect the other battery modules 34 if any battery module 34 fails (e.g., experiences a high temperature event). The dividers may be made of a material that does not oxidize or otherwise become damaged when exposed to electrical arcs and/or high temperatures.

The housing 28 of each battery pack 20 may have a box-like structure, and may be shaped to allow the battery modules 34 of the battery pack 20 to be arranged in a single layer on a common horizontal plane to decrease the height of the battery pack 20. In some embodiments, the housing 28 may be watertight (e.g., to about 1 meter) and may have a rating for dust and water resistance (e.g., an International Protection (IP) 67 rating). The housing 28 may be configured to contain any failures (e.g., electric arcs, fires, etc.) within the battery pack 20 in order to prevent damage to other battery packs 20 or other portions of the bus 10 if a component inside a battery pack 20 fails. In some embodiments, the housing 28 may be constructed of corrosion and puncture resistant materials. For example, the materials of which the housing 28 may be constructed may include composite materials, Kevlar, stainless steel, aluminum, high strength plastics, etc.

In addition to the battery modules 34, the housing 28 may also enclose a battery management system (BMS) 30 that monitors or controls the operation of the battery modules 34 and a thermal management system 32 that assists in managing the temperature of the battery modules 34 of the battery pack 20 (i.e., heat, cool, etc.). As described in more detail elsewhere herein, the BMS 30 and/or one or more other pack controllers may monitor the state (e.g., humidity, state of charge (SOC), current, temperature, etc.) of the battery modules 34 and the battery cells 38 in the battery pack 20, and may control the operations of the battery pack 20 to ensure that power is safely and efficiently directed into and out of the battery pack 20. The thermal management system 32 may include components that circulate air and/or a liquid coolant to the battery modules 34 to heat or cool the battery modules 34. These components may include, for example, circulating fans, coolant conduits, heat exchangers, etc. that assist in circulating air and/or a coolant through the battery modules 34 packaged in the housing 28 to manage the temperature of the battery pack 20.

The battery system 14 may include an energy storage management (ESM) system 26 that communicates with the BMS 30 included in the battery pack 20 to control the operation of the battery system 14 on a per-battery pack 20 basis. The ESM system 26 may include circuit boards, electronic components, sensors, and controllers that monitor the performance of the components (e.g., the battery packs 20, the battery modules 34, and the battery cells 38) of the battery system 14 based on sensor input (e.g., voltage, current, temperature, humidity, etc.), provide feedback (e.g., alarms, alerts, etc.), and control the operation of the battery system 14 for safe and efficient operation of the bus 10. In some embodiments, the ESM system 26 may perform charge balancing between different battery packs 20, battery modules 34 and/or battery cells 38 during recharging or during operation of the bus 10. The ESM system 26 may also thermally and/or electrically isolate sections (e.g., battery cells 38, battery modules 34, battery packs 20, etc.) of the battery system 14 when one or more sensor readings (e.g., temperature, etc.) exceed a threshold value. As will be described in more detail elsewhere herein, in some embodiments, the ESM system 26 may initiate or control energy discharge from all or selected battery packs 20, battery modules 34, or battery cells 38 based on the occurrence of predefined trigger events.

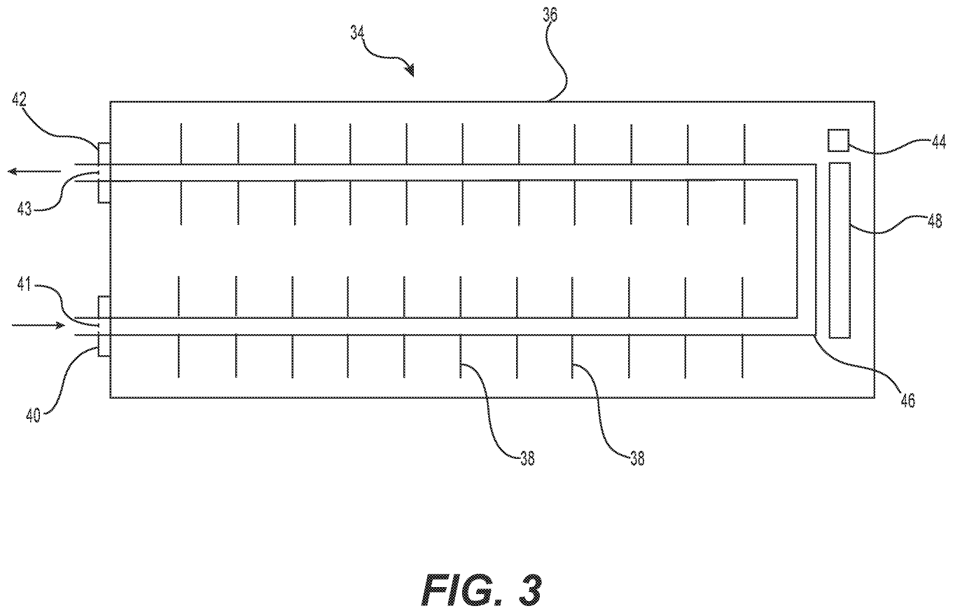

FIG. 3 is a schematic illustration of an exemplary battery module 34 of the battery system 14 of FIG. 2, according to the present disclosure. The battery module 34 includes a casing 36 that encloses the plurality of battery cells 38 of the battery module 34 therein. Similar to the housing 28 of the battery pack 20, the casing 36 may be configured to contain any failures (e.g., electric arcs, fires, etc.) of the battery cells 38 of the battery module 34 within the casing 36 in order to prevent the damage from spreading to other battery modules 34 of the battery pack 20. The casing 36 may be made of any material suitable for this purpose. In some embodiments, the casing 36 may be constructed of one or more of materials such as, for example, Kevlar, aluminum, stainless steel, composite materials, etc. In some embodiments, the casing 36 may be substantially air-tight to hermetically seal the battery cells 38 of the battery module 34 therein.

In general, the battery cells 38 may have any shape and structure (e.g., a cylindrical cell, a prismatic cell, a pouch cell, etc.). Typically, all the battery cells 38 of a battery module 34 may have the same shape. However, it is also contemplated that different shaped battery cells 38 may be packed together in the casing 36 of a battery module 34. In addition to the battery cells 38, the casing 36 may also include sensors (e.g., a temperature sensor, a voltage sensor, a humidity sensor, etc.) and controllers (e.g., a battery module controller 44) that monitor and control the operation of the battery cells 38. Although not illustrated, the casing 36 also may include electrical circuits (e.g., voltage and current sense lines, low voltage lines, high voltage lines, etc.), and related accessories (e.g., fuses, switches, etc.), that direct electrical current to and from the battery cells 38 during recharging and discharging.

As explained previously, the battery cells 38 of the battery module 34 may be electrically connected together in any manner (e.g., in parallel, in series, or in groups of series-connected battery cells 38 connected together in parallel). These battery cells 38 may also be physically arranged in any manner. In some embodiments, the battery cells 38 of a battery module 34 may be packed together tightly to fill the available volume within the casing 36. In some embodiments, the battery cells 38 may be arranged together to form multiple groups (e.g., bricks) of battery cells 38 electrically connected together in series. The multiple bricks (each comprising multiple battery cells 38 electrically connected together) may then be electrically connected together (e.g., in series or parallel) and packaged together in the casing 36. In some embodiments, one or more sensors may be associated with each brick of the battery module 34. Terminals (e.g., positive and negative terminals) electrically connected to the battery cells 38 of the battery module 34 may be provided on an external surface of the casing 36.

The casing 36 may also include a coolant loop 46 configured to circulate a coolant through the battery module 34. The coolant loop 46 may comprise fluid conduits arranged to pass through, or meander (e.g., zigzag) through, the volume enclosed by the casing 36. An inlet port 40 and an outlet port 42 of the casing 36 may fluidly couple the coolant loop 46 to a coolant circuit of the battery system 14. The coolant may enter the coolant loop 46 through the inlet port 40 and may exit the casing 36 through the outlet port 42. In some embodiments, where the battery module 34 is air cooled, the casing 36 may also include inlet and outlet vents configured to direct cooling air into and out of the casing 36. In some embodiments, the coolant may cool all the battery modules 34 of a battery pack 20 before exiting the battery pack 20. That is, the coolant loops 46 of the battery modules 34 of the battery pack 20 may be connected in series such that the coolant exiting one battery module 34 enters the coolant loop 46 of another battery module 34. In some embodiments, coolant may be directed into each battery module 34 individually (for e.g., from a common coolant gallery of the battery pack 20). In some embodiments, groups of battery modules 34 within a battery pack 20 may be fluidly connected in series and multiple series-connected battery modules 34 may be connected together in parallel.

During operation of the battery system 14, the battery cells 38 of the battery module 34 release heat. This released heat may be transferred to the coolant circulating through the coolant loop 46 and then removed from the casing 36 along with the coolant. In general, any known fluid may be used as the coolant. In some embodiments, water (with suitable additives such as antifreeze, etc.) or another suitable liquid may be used as the coolant. The battery cells 38 of the battery module 34 may be arranged to enhance heat dissipation into the coolant circulating through the battery module 34. For example, in some embodiments, the battery cells 38 may be in close thermal contact with the coolant loop 46. In some embodiments, the battery cells 38 may be placed in close thermal contact with metal plates that serve as heat conducting pathways to the coolant loop 46.

The battery module 34 may also include one or more heaters 48 positioned within the casing 36 (or in close thermal contact with the casing 36). In general, any type of heating device (e.g., a resistance heater, a positive temperature coefficient (PTC) heater, etc.) may be used as the heater 48. In some embodiments, the heater 48 may be a PTC cartridge heater. Unlike a resistance heater which generates heat at a constant rate, a PTC heater may use PTC resistive elements which generate heat at a lower rate at higher temperatures. Therefore, a PTC heater is self-regulating to a fixed working temperature.

In some embodiments, the heater 48 (or the multiple heaters 48) of each battery module 34 may be powered solely by the battery cells 38 of that battery module 34. The heater 48 may be activated by the battery module controller 44 and/or by another controller (e.g., the ESM system 26, the BMS 30, etc.) of the battery system 14. When the heater 48 is activated, it generates heat using the energy stored in the battery cells 38 of that battery module 34. Consequently, the stored energy (or SOC) of the battery cells 38 in the battery module 34 decrease as a result of activation of the heater 48. The heat dissipated by the heater 48 may be removed from the battery module 34 by the circulating coolant (or by conduction). A temperature sensor (or thermistor) of the battery module 34 may monitor the heat dissipated by the heater 48.

The heater 48 may be positioned at any location within the casing 36. In general, the location of the heater 48 may be selected such that the maximum energy discharged by the heater 48 does not damage (or jeopardize the safety of) the battery cells 38 of the battery module 34. Therefore, in some embodiments, the heater 48 may be spaced away from (i.e., not directly in contact with) the battery cells 38 such that the heater 48 is thermally isolated from the battery cells 38. The location of the heater 48 may also be selected such that the dissipated heat can be easily transferred to the body of the battery pack 20 (thus allowing the heater 48 to dissipate more heat without a resulting increase in temperature). Therefore, in some embodiments, the heater 48 may be positioned in direct contact with the metal frame of the battery pack 20 to enhance heat conduction. In some embodiments, the heater 48 may be positioned close to (as illustrated in FIG. 3) the coolant loop 46 of the battery module 34 so that the dissipated heat may be easily transferred to the coolant circulating through the coolant loop 46. It is also contemplated that, in some embodiments, the heater 48 may be positioned within the coolant loop 46 (i.e., submerged in the coolant of the coolant loop 46). In some embodiments, as illustrated in FIG. 3, the heater 48 may be positioned about midway of the coolant loop 46 in the battery module 34. That is, the heater 48 may be positioned proximate to (on within) the coolant loop 46, and substantially equidistant from the inlet port 40 and the outlet port 42.

Although a single heater 48 is illustrated in FIG. 3, in some embodiments, multiple heaters (similar to the heater 48) may be positioned within the casing 36 of each battery module 34. Each of these multiple heaters 48 may be powered by the battery cells 38 of that battery module 34 so that activating these multiple heaters 48 may discharge energy from all the battery cells 38 at a faster rate as compared to a case when a single heater 48 is used. In some embodiments, a first group of battery cells 38 of the battery module 34 (e.g., a brick) may power a first heater 48, and a second group of battery cells 38 of the battery module 34 may power a second heater 48. In such an embodiment, activating the first heater 48 may selectively discharge energy from the first group of battery cells 38, and activating the second heater 48 may selectively discharge energy from the second group of battery cells 38. The multiple heaters 48 may be positioned adjacent to each other or spaced apart from each other in the casing 36. In some embodiments, the multiple heaters 48 may be positioned such that desired regions of the battery module 34 can be selectively discharged by activating different heaters 48.

As explained previously, the heater 48 may be activated by the BMS 30 alone or in cooperation with the battery module controller 44 and/or the ESM system 26. In some embodiments, the BMS 30 may simultaneously activate the heaters 48 embedded in (inserted in, positioned in, included in, etc.) each battery module 34 of the battery system 14 to discharge energy from the battery cells 38 of every battery module 34, and thereby, reduce the SOC of the entire battery system 14. In some embodiments, the BMS 30 may selectively activate the heaters 48 embedded in selected battery modules 34 to preferentially discharge energy from (and thereby reduce the SOC of) the selected battery modules 34. For example, if sensors detect that one battery module 34 of a battery pack 20 includes a damaged battery cell 38, the BMS 30 may selectively activate the heaters 48 embedded in all the other battery modules 34 of the battery pack 20 (i.e., except the battery module 34 with the damaged battery cell 38) to safely decrease the SOC of the battery pack 20. In embodiments where multiple heaters 48 are embedded in a battery module 34, the BMS 30 may also be configured to selectively activate some heaters 48 of the battery module 34 to preferentially discharge energy from selected battery cells 38 (e.g., bricks) of the battery module 34.

The BMS 30 may activate the heaters 48 embedded in the battery modules 34 to discharge energy from (and thus decrease the SOC of) the battery system 14 of a stranded (or otherwise incapacitated) bus 10 before service personnel operate on (repair, remove the batteries from, etc.) the bus 10. The battery system 14 of the bus 10 may store a relatively large amount of energy (e.g., between about 200-700 KWh). Operating on a bus 10 with such a large amount of stored energy may be undesirable. Dissipating the stored energy from the battery system 14 by activating the heaters 48 lowers the SOC of the battery system 14. After the SOC of the battery system 14 has been lowered to a suitable level, the heaters 48 may be deactivated. Although the discussion above describes embedding a heater 48 in a battery module 34 of a battery pack 20, this is merely exemplary. In general, any electric load may be embedded in a battery module 34 to selectively dissipate energy from the battery cells 38 of the battery module 34

In general, the heat produced by the heaters 48 may be dissipated from the battery system 14 by conduction, convection, or radiation. The heaters 48 may be positioned in the battery modules 34 such that the heat produced by them can be removed without overheating the battery cells 38 of the battery module 34. In some embodiments, the heat produced by the heaters 48 of a battery module 34 may be used to increase the temperature of the battery cells 38 of the battery module 34. In some embodiments, the inlet port 40 and/or the outlet port 42 of the coolant loop 46 may be selectively opened and closed (e.g., using adjustable valves 41 and 43 shown by the dashed lines in FIG. 3) by the BMS 30, based on sensor readings (e.g., humidity, temperature, etc.) from within the battery module 34. The BMS 30 may use these adjustable valves to redirect the coolant flow within the battery system 14 based on the local conditions within the battery modules 34.

The implementation of a heater 48 in every battery module 34 of the battery system 14 (as opposed to providing a coolant heater external to the battery system 14) may activate the battery cells 38 of the battery system 14 to be heated more quickly and efficiently. Further, locating the heater 48 to be substantially in the middle of the coolant loop 46 may activate the heat dissipated by the heater 48 to be distributed throughout the coolant loop 46 which may result in improved heating performance in a short amount of time.

The BMS 30 (and/or other controllers of the battery system 14) may selectively activate the heaters 48 of a battery module 34 in response to any triggering event. In some embodiments, the triggering event may include input from a human operator or one or more sensors of the bus 10. In response to the triggering signal, the BMS 30 may selectively activate one or more of the heaters 48 embedded in selected battery modules 34 (i.e., all or some of the battery modules 34).

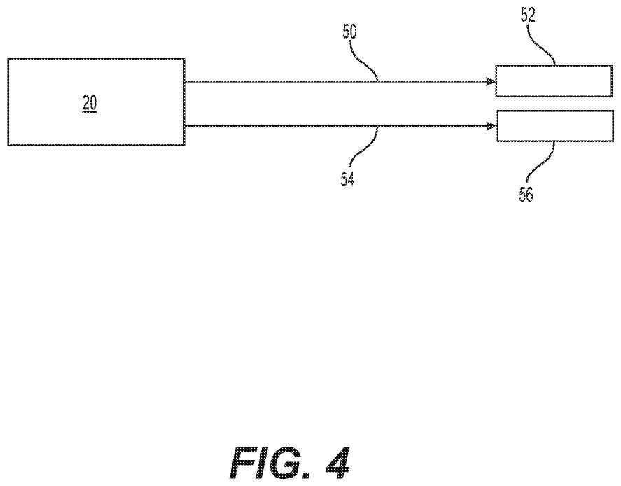

FIG. 4 is a schematic illustration of connections between the battery pack 20 of FIG. 2 and peripheral devices or systems of the bus 10 of FIGS. 1A and 1B, according to the present disclosure. As illustrated, the schematic in FIG. 4 includes the battery pack 20, a high voltage (HV) bus bar 50, a high voltage peripheral device or system 52, a low voltage bus bar 54, and a low voltage peripheral device or system 56. The battery pack 20 may be electrically connected (e.g., through one or more electrical terminals 62, 66 not illustrated in FIG. 4) to the high voltage bus bar 50. The high voltage bus bar 50 may provide one or more electrical connections between the battery pack 20 and the high voltage peripheral device or system 52 for carrying high voltage power (e.g., at greater than or equal to approximately 100 V) from the battery pack 20 to the high voltage peripheral device or system 52. The high voltage peripheral device or system 52 may include, for example, devices or systems of the bus 10 used during operation of the bus 10, such as the powertrain 24, an heating, ventilation, and air conditioning (HVAC) system, an external DC/DC system, or the like.

Similarly, the battery pack 20 may be electrically connected to the low voltage bus bar 54. The low voltage bus bar 54 may provide one or more electrical connections between the battery pack 20 and the low voltage peripheral device or system 56 for carrying low voltage power (e.g., at less than 100 V) from the battery pack 20 to the low voltage peripheral device or system 56. The low voltage device or system 56 may include, for example, devices or systems that are operational when the bus 10 is not in use or is in an idle state, such as a fire suppression system, a security system, a lighting system, an indicator, a cooling pump, or the like. In some implementations, the low voltage device or system 56 may include any device or system of the bus 10 that does not operate on a high voltage energy storage system.

Although FIG. 4 illustrates a single battery pack 20, there may be multiple battery packs 20 electrically connected to the high voltage bus bar 50 or the low voltage bus bar 54, and the multiple battery packs 20 may be organized into electrically parallel strings of battery packs 20 (with the battery packs 20 included in a string connected in series). In addition, the illustration of a single high voltage peripheral device or system 52 and a single low voltage peripheral device or system 56 is merely exemplary and some embodiments may include multiple high voltage peripheral devices or systems 52 and/or multiple low voltage peripheral devices or systems 56.

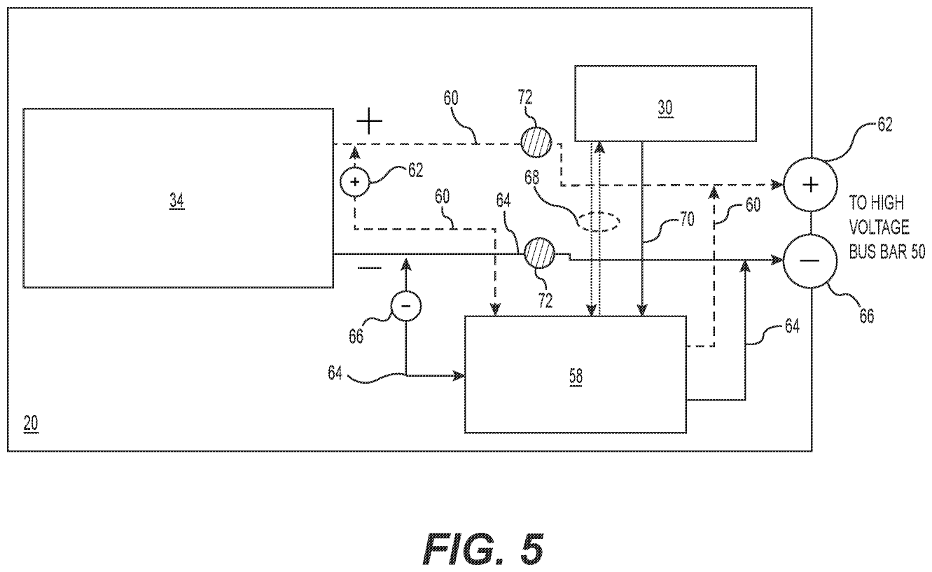

FIG. 5 is a schematic illustration of a first configuration of a battery pack 20 of the battery system 14 of FIG. 2 that includes a DC/DC pre-charger 58, according to the present disclosure. The schematic illustrated in FIG. 5 includes a battery pack 20, a BMS 30, a battery module 34, a high voltage bus bar 50, a DC/DC pre-charger 58, positive electrical connections 60, positive electrical terminals 62, negative electrical connections 64, negative electrical terminals 66, software layer communication lines 68, a hardware layer communication line 70, and battery pack contactors 72. FIG. 5 illustrates a positive battery pack contactor 72 on a positive electrical connection 60 and a negative battery pack contactor 72 on a negative electrical connection 64. Any of the components of a battery pack 20 may be configured for bidirectional current flow. For example, the components may be configured to import energy into the battery pack 20 or export energy out of the battery pack 20 (e.g., pre-charge or discharge a HV bus bar 50).

The DC/DC pre-charger 58 may include one or more electrical circuits or electromechanical devices that pre-charges or discharges the HV bus bar 50. For example, the DC/DC pre-charger 58 may draw power from the battery module 34 and may provide the power to the HV bus bar 50 in a controlled manner to charge capacitances on the HV bus bar 50, thereby causing the voltage of HV bus bar 50 to rise. As one specific example of providing power in a controlled manner, the DC/DC pre-charger 58 may limit the maximum current throughput allowed (e.g., by limiting the pre-charge current to less than 5 amps (A)). As another specific example of providing power in a controlled manner, the DC/DC pre-charger 58 may ramp the amount of power provided to the HV bus bar 50 to a target amount by stepping through multiple intermediate voltage targets between the DC bus bar 50 voltage and the battery pack 20 voltage. For example, the DC/DC pre-charger 58 may start pre-charging operations at 0V and may increase the voltage to 10V, then to 25V, then to 50V, then to 100V in sequence and in a linear or exponential manner.

As illustrated in FIG. 5, the DC/DC pre-charger 58 may be electrically connected to the battery module 34 via a positive electrical terminal 62 and a negative electrical terminal 66, which may be separate components from the DC/DC pre-charger 58, and thus separately controllable (e.g., control of on/off states) from the DC/DC pre-charger 58. This electrical connection may meet electrical connections 60, 64 from the battery module 34 between the battery module 34 and battery pack contactors 72. The DC/DC pre-charger 58 may be further electrically connected to the electrical connections 60, 64 from the battery module 34 between the battery pack contactors 72 and the electrical contactors 62, 66 to the high voltage bus bar 50. The DC/DC pre-charger 58 may include one or more relays and fuses (e.g., thermal fuses, thermal-magnetic breakers, pyrotechnic fuses, etc.) for protection from the high voltage connections to the battery module 34 and/or the high voltage bus bar 50.

In some embodiments, the DC/DC pre-charger 58 may be located in an ancillary bay of the battery pack 20. Additionally, or alternatively, the DC/DC pre-charger 58 may be included in the coolant system of the battery pack 20. For example, the DC/DC pre-charger 58 may have one or more mechanical connections to the coolant loop 46. This may reduce or eliminate a need for a DC/DC pre-charger 58 external to the battery pack 20 or for independent cooling channels, heat sinks, or fans for cooling the DC/DC pre-charger 58.

The DC/DC pre-charger 58 may be bidirectional. For example, the DC/DC pre-charger 58 may receive electrical power from the battery module 34 and may control provisioning of the power to the high voltage bus bar 50. Alternatively, the DC/DC pre-charger 58 may discharge power from the high voltage bus bar 50.

The software layer communication lines 68 may include wired or wireless connections for bidirectional communication between the DC/DC pre-charger 58 and the BMS 30. For example, the software layer communication lines 68 may include a controller area network (CAN) bus, a serial communication line, and/or the like. As described in more detail elsewhere herein, the BMS 30 may send instructions to the DC/DC pre-charger 58 to configure the DC/DC pre-charger 58 to operate in a particular manner and/or may receive data related to the operation of the DC/DC pre-charger 58 via the software layer communication lines 68. The hardware communication line 70 may include an electrical connection for logic and/or voltage signaling from the BMS 30 to the DC/DC pre-charger 58, or vice versa. As described in more detail elsewhere herein, the BMS 30 may provide enabling/disabling signaling to the DC/DC pre-charger 58 via the hardware communication line 70. The software layer communication lines 68 and/or the hardware communication lines 70 may form a communication bus bar and the BMS 30 may be controlled by the ESM system 26.

The battery pack 20 may include one or more additional components not illustrated in FIG. 5 (or elsewhere herein). For example, the battery pack 20 may include a high voltage interlock loop (HVIL), which may be configured to protect people from electrical power stored in the battery pack 20 during maintenance, assembly, etc. In some embodiments, the BMS 30 may activate or deactivate the HVIL, such as when the bus 10 is in a maintenance facility. In some embodiments, an activate signal for enabling the DC/DC pre-charger 58 via the software layer communication lines 68 and/or the hardware layer communication line 70 may be part of the enabling signal for the HVIL. For example, when the DC/DC pre-charger 58 is activated to import power to or export power from a battery pack 20, DC terminal pins for the bus 10 may be deactivated for safety.

In this way, control by the BMS 30 may facilitate independent operation of the battery pack 20, regardless of application. For example, communications with components outside of the battery pack 20 may be reduced as the battery pack 20 may just have to be instructed to start pre-charging or discharging operations.

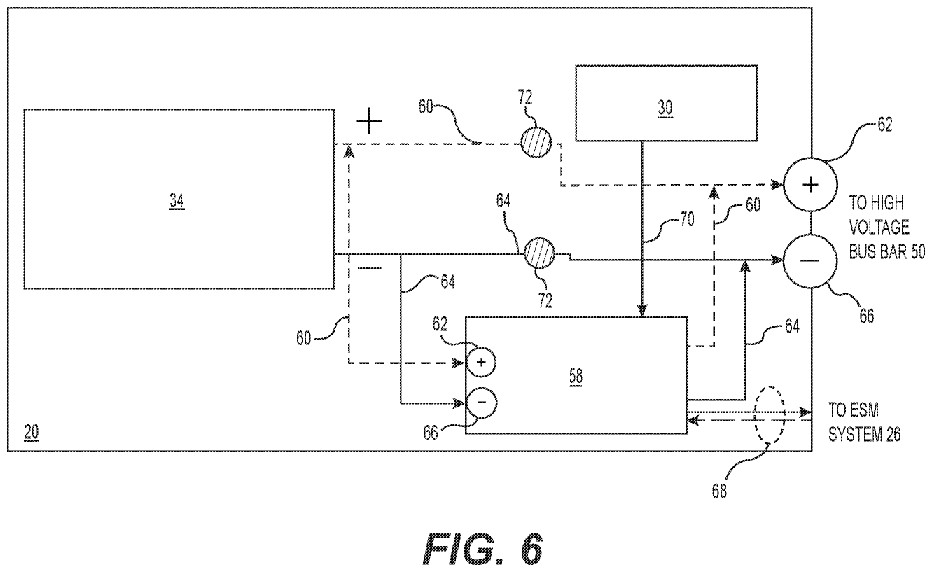

FIG. 6 is a schematic illustration of a second configuration of a battery pack 20 of the battery system 14 of FIG. 2 that includes a DC/DC pre-charger 58, according to the present disclosure. The battery pack 20 illustrated in FIG. 6 may include some of the same components as the battery pack 20 illustrated in FIG. 5. For example, the second configuration may include battery pack contactors 72 that can be opened or closed by the DC/DC pre-charger 58 (or the BMS 30) depending on whether the DC/DC pre-charger 58 is to discharge or pre-charge the HV bus bar 50. However, rather than being connected to the BMS 30 via the software layer communication lines 68, the DC/DC pre-charger 58 of FIG. 6 may be connected directly to the ESM system 26 (not illustrated in FIG. 6) via the software layer communication lines 68. Thus, in some embodiments, the ESM system 26, rather than the BMS 30, may directly control certain operations of the DC/DC pre-charger 58. For example, the ESM system 26 may set whether the DC/DC pre-charger 58 is operating in a charging mode (e.g., where the DC/DC pre-charger 58 is pre-charging the HV bus bar 50) or a discharging mode (e.g., where the DC/DC pre-charger 58 is discharging the HV bus bar 50), may set or modify voltage limits or targets for the DC/DC pre-charger 58, may power on or power off the DC/DC pre-charger 58, and/or the like.

Although the DC/DC pre-charger 58 may be connected to the ESM system 26, rather than the BMS 30, via the software layer communication lines 68 in the example of FIG. 6, the DC/DC pre-charger 58 may be connected to the BMS 30 via the hardware layer communication line 70. With this configuration, the BMS 30 may provide enabling/disabling signaling to the DC/DC pre-charger 58 via the hardware layer communication line 70 (e.g., to power the DC/DC pre-charger 58 on or off) and the ESM system 26 may provide signaling for voltage targets or limits, direction of operation (e.g., discharge or pre-charge), and/or the like. In this way, certain embodiments may provide for localized powering on or off of a DC/DC pre-charger 58, which may reduce latency in powering on or off, while a centralized ESM system 26 may coordinate parameters for operation across multiple DC/DC pre-chargers 58.

In some embodiments, a positive electrical terminal 62 and a negative electrical terminal 66 may be included in the DC/DC pre-charger 58 and may be controlled in conjunction with the DC/DC pre-charger 58. For example, the positive electrical terminal 62 and the negative electrical terminal 66 may be controlled by the same enabling/disabling signals as the DC/DC pre-charger 58 and/or may be controlled directly by the DC/DC pre-charger 58 based on signaling received from the ESM system 26. Although the schematics of FIGS. 5 and 6 have been described separately, the schematics may be combined in some embodiments. For example, the battery pack 20 of FIG. 5 may be modified in some embodiments such that the DC/DC pre-charger 58 is directly connected to the ESM system 26, as in the schematic of FIG. 6.

In this way, control by the ESM system 26 may facilitate efficient external and centralized control of pre-charging or discharging operations. For example, the ESM system 26 may facilitate optimized control of multiple DC/DC pre-chargers 58. Additionally, or alternatively, use of a centralized ESM system 26 may facilitate better fault handling through direct communications with components across multiple battery packs 20.

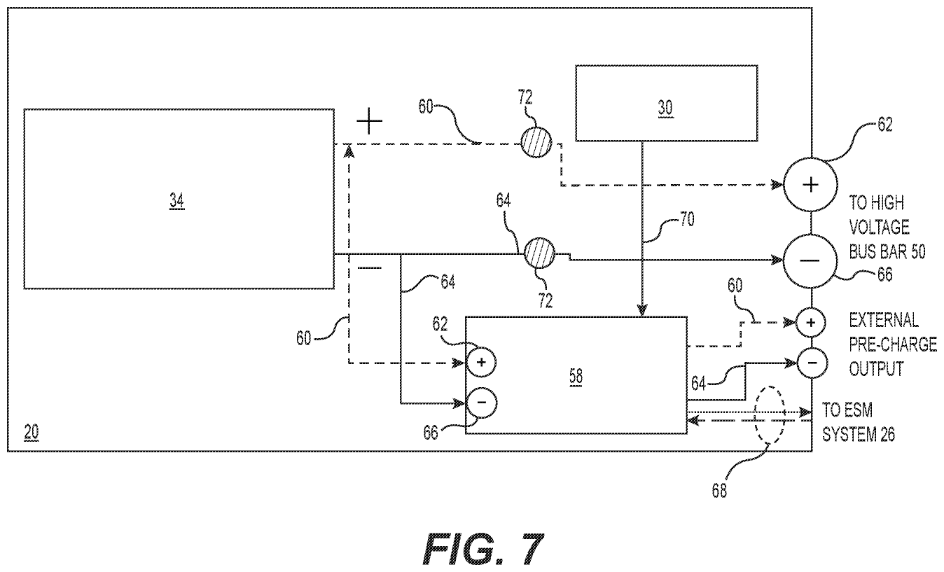

FIG. 7 is a schematic illustration of a third configuration of a battery pack of the battery system of FIG. 2 that includes a DC/DC pre-charger, according to the present disclosure. The battery pack 20 illustrated in FIG. 7 may include some of the same components as the battery pack 20 illustrated in FIG. 6. However, rather than being electrically connected to electrical connections 60, 64 between the battery pack contactors 72 and the electrical terminals 62, 66 to the high voltage bus bar 50, the DC/DC pre-charger 58 of FIG. 7 may be electrically connected directly to dedicated electrical terminals 62, 66 at an interface between the battery pack 20 and other components external to the battery pack 20. Thus, in some embodiments, the DC/DC pre-charger 58 may have a dedicated external pre-charge output (shown in FIG. 7 as “EXTERNAL PRE-CHARGE OUTPUT”) from or input to the battery pack 20 (rather than sharing electrical terminals with the battery module 34).

Although the schematics of FIGS. 5, 6, and 7 have been described separately, the schematics may be combined in some embodiments. For example, the battery pack 20 of FIG. 5 may be modified in some embodiments such that the DC/DC pre-charger 58 is electrically connected to components external to the battery pack 20 via dedicated terminals 62, 66, as in the schematic of FIG. 7.

In this way, the external pre-charge output may facilitate using a single battery pack 20 to pre-charge or discharge a string of battery packs 20, rather than using multiple battery packs 20 working in tandem.

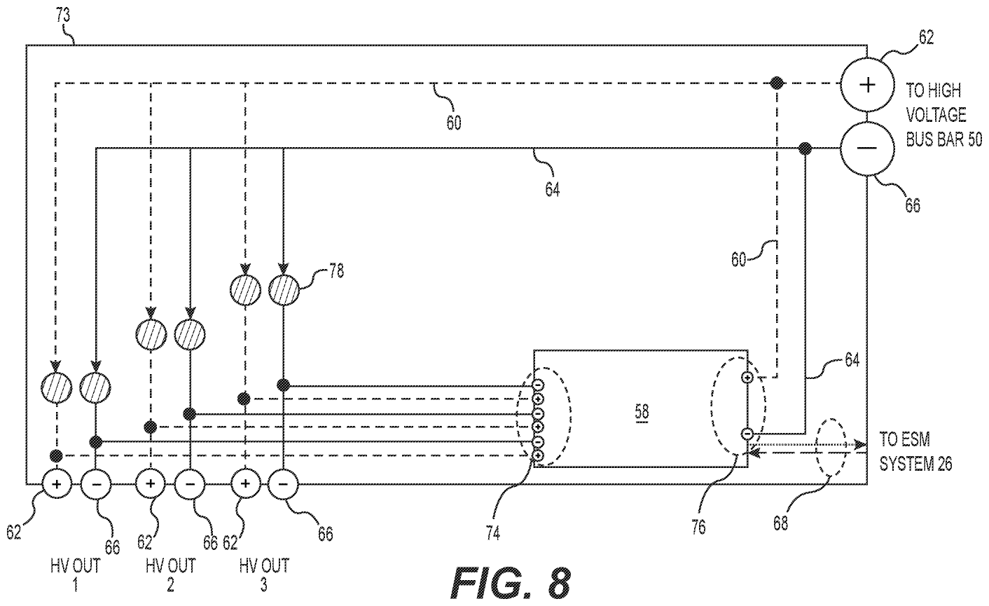

FIG. 8 is a schematic illustration of a junction box 73 that includes a DC/DC pre-charger 58, according to the present disclosure. As illustrated in FIG. 8, the junction box 73 may include the pre-charger 58 where various output terminals 62, 66 (collectively identified by reference number 74) of the DC/DC pre-charger 58 are electrically connected to electrical connections 60, 64 between various contactors 78 (illustrated as shaded circles) and various HV outputs (“HV OUT 1,” “HV OUT 2,” and “HV OUT 3”) of the junction box 73. As further illustrated in FIG. 8, inputs terminals 62, 66 (collectively identified by reference number 76) of the DC/DC pre-charger 58 may be electrically connected to electrical connections 60, 64 between the various contactors 78 and electrical terminals 62, 66 to the high voltage bus bar 50. In some embodiments, the contactors 78 may be separate components from the battery pack 20. For example, certain implementations may include separate battery pack contactors 72 and contactors 78 to control connection to a bus bar.

In this configuration, each individual output from the junction box 73 may be individually powered. For example, one or more of the HV outputs (e.g., HV OUT 1, HV OUT 2, and HV OUT 3) may be closed while one or more other HV outputs are opened for pre-charging or discharging. Additionally, or alternatively, one or more parameters (e.g., voltage targets, voltage limits, etc.) for pre-charging or discharging may be applied to each HV output separately. For example, the DC/DC pre-charger 58 may apply different one or more parameters to different HV outputs. Additionally, or alternatively, if there is a high voltage event or non-catastrophic equipment failure on a high voltage out circuit, the circuit may be opened and discharged without disabling the entire high voltage system. Certain embodiments may selectively power on portions of the high voltage system without bringing the entire high voltage system online. For example, if a battery thermal management system (BTMS) is needed while the bus 10 is charging, certain embodiments may just power on the BTMS without powering on other elements of the high voltage system, such as an air compressor, a drivetrain, or an HVAC system.

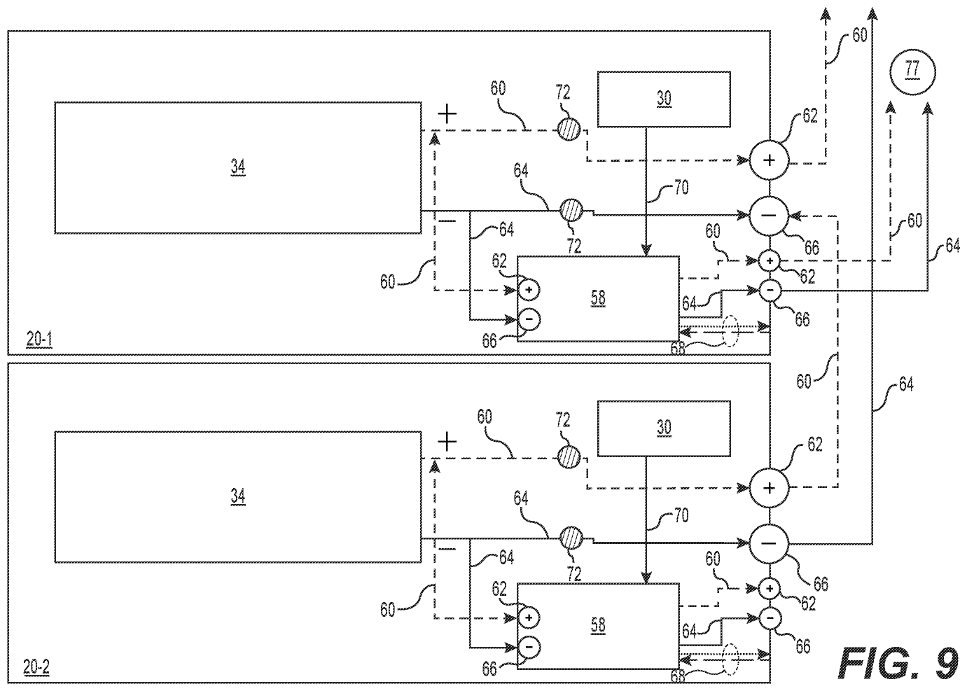

FIG. 9 is a schematic illustration of a string of battery packs 20 of the battery system 14 of FIG. 2, according to the present disclosure. For example, FIG. 9 illustrates a string of two battery packs 20 (battery packs 20-1 and 20-2) electrically connected to each other in series. While only two battery packs 20 are depicted in the string of FIG. 9, it is contemplated that a greater number of battery packs 20 can be included in a string, as needed or required. Although FIG. 9 illustrates battery packs 20 that are each configured in a manner similar to that illustrated in FIG. 7, battery packs 20 with other configurations according to the disclosure herein may be electrically connected in a string of battery packs 20. In some embodiments, two or more strings of battery packs 20 may be electrically connected in parallel.

As further illustrated in FIG. 9, certain electrical terminals 62, 66 of the battery pack 20-1 may be electrically connected to a DC bus bar 77. This configuration may utilize a wide output voltage range to pre-charge the bus bar 77 via an external connection, which may reduce or eliminate the need to rely on two or more DC/DC pre-chargers 58 operating in tandem with each other, thereby making the process of pre-charging more efficient. In addition, this configuration may increase a redundancy of certain systems of the bus 10. For example, this may increase redundancy in a system with a single string of two battery packs 20 in parallel, where the DC/DC pre-chargers 58 may operate in tandem, by reducing or eliminating a failure of one pre-charger 58 causing a failure of the entire string. Continuing with the previous example, a bus bar may still be pre-charged despite a failed pre-charger 58 in this example.

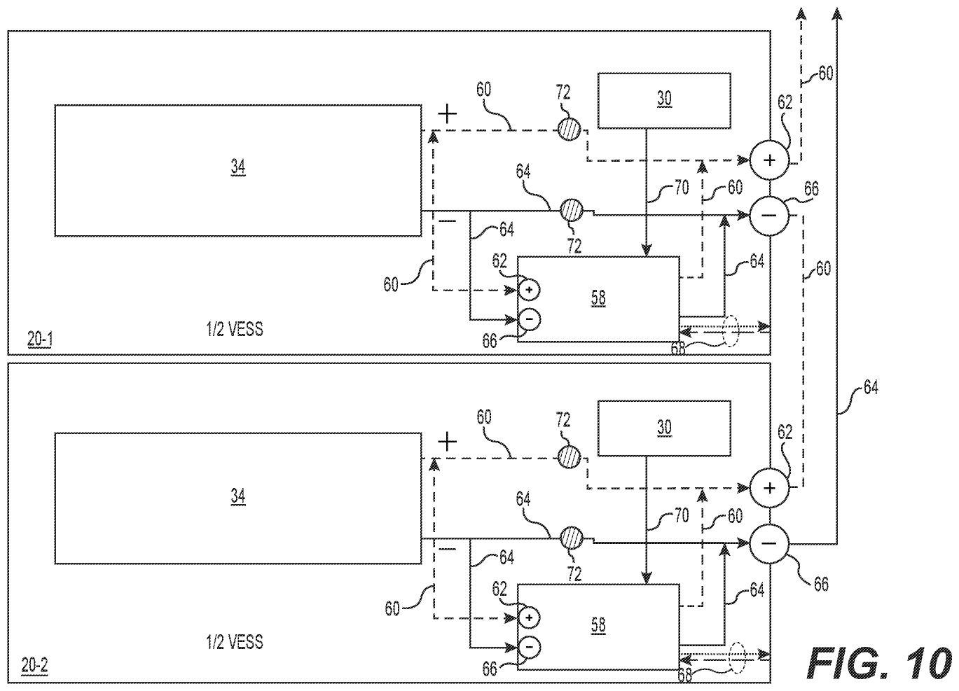

FIG. 10 is another schematic illustration of a string of battery packs 20 of the battery system 14 of FIG. 2, according to the present disclosure. For example, FIG. 10 illustrates a string of two battery packs 20 (battery packs 20-1 and 20-2) electrically connected to each other in series. Although FIG. 10 illustrates battery packs 20 configured in a manner similar to that illustrated in FIG. 6, battery packs 20 with other configurations according to the disclosure herein may be electrically connected in a string of battery packs 20. As described herein for other strings of battery packs 20, multiple strings of battery packs 20 may be electrically connected in parallel. In some embodiments, different configurations of battery packs 20 may be included in the same string of battery packs 20 and/or in different strings of battery packs 20.

As used herein, “Vess” is an acronym for voltage-energy storage system. In the example illustrated in FIG. 10, each high voltage battery pack 20 may contribute half of the overall string voltage (illustrated as “1/2 Vess”). As such, the DC/DC pre-chargers 58 in each battery pack 20 may pre-charge approximately half of the total string voltage or may discharge approximately half of the voltage from the HV bus bar 50.

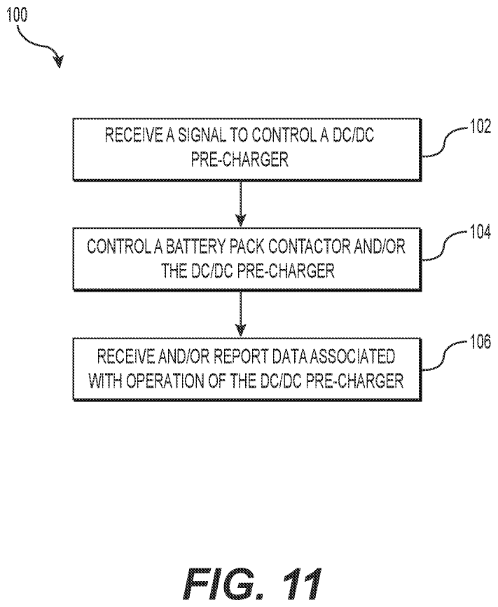

FIG. 11 illustrates an exemplary method 100 of controlling pre-charge operations of a DC/DC pre-charger 58 using a BMS 30, according to the present disclosure. Although the method 100 is described as being performed by the BMS 30, in some embodiments the ESM system 26 and/or one or more controllers associated with the battery system 14 may perform the method 100 (or portions of the method 100). In some implementations, a combination of the ESM system 26, the BMS 30, and/or the one or more controllers may perform the method 100. For example, the ESM system 26 may perform the operations illustrated at 102 and the BMS 30 may perform the operations illustrated at 104 and 106.

The method 100 may include, at operation 102, receiving a signal to control the DC/DC pre-charger 58. For example, the BMS 30 may receive the signal from the ESM system 26 after the engine of a bus 10 is started and the ESM system 26 boots up. The signal may include an instruction for the BMS 30 to enable the DC/DC pre-charger 58 (e.g., to power on the DC/DC pre-charger 58), may provide one or more parameters to the DC/DC pre-charger 58, and/or the like. A parameter may include an output power limit, a maximum current limit, an indication of whether the DC/DC pre-charger 58 is to pre-charge the HV bus bar 50 or discharge the HV bus bar 50, a target voltage for the HV bus bar 50 or the DC/DC pre-charger 58, a time limit parameter for certain operations (e.g., a timeout fault after a certain amount of time), and/or the like. In some embodiments, various sets of parameters may be applied to a DC/DC pre-charger 58. For example, a first set of parameters may be applied to the DC/DC pre-charger 58 to allow for a faster pre-charge or discharge than a second set of parameters for certain scenarios.

As illustrated at 104, the method 100 may further include controlling a battery pack contactor 72 and/or the DC/DC pre-charger 58. For example, the BMS 30 may send an instruction to the DC/DC pre-charger 58 to operate according to the one or more parameters (e.g., the instruction may cause the DC/DC pre-charger 58 to ramp voltage on the HV bus bar 50 to a target voltage, may cause the DC/DC pre-charger 58 to start to discharge the HV bus bar 50, and/or the like). Additionally, or alternatively, the BMS 30 may cause one or more battery pack contactors 72 to open or close depending on whether the DC/DC pre-charger 58 is to discharge or pre-charge the HV bus bar 50. Additionally, or alternatively, the BMS 30 may configure the DC/DC pre-charger 58 to provide data related to the operation of the DC/DC pre-charger 58 to the ESM system 26 and/or the BMS 30. For example, the BMS 30 may configure the DC/DC pre-charger 58 to provide certain statistics related to the operation and/or the manner in which the DC/DC pre-charger 58 is to provide the statistics (e.g., in a stream of data, according to a schedule, etc.).

The method 100 may further include, at 106, receiving and/or reporting data associated with the operation of the DC/DC pre-charger 58. For example, the DC/DC pre-charger 58 may provide the data to the BMS 30 via the software communication lines 68, and the BMS 30 may store the data in memory and/or may provide the data to the ESM 26. In some embodiments, the BMS 30 may process the data prior to, or in connection with, receiving and/or reporting the data. For example, the BMS 30 may aggregate the data for a time period, may filter the data for outlier data points, may generate warnings or other alarms based on the data, and/or the like. This may reduce an amount of data that the BMS 30 has to record and/or report, may facilitate more efficient aggregation of data from multiple BMSs 30 by the ESM system 26, and/or the like, thereby conserving computing resources of the battery system 14.

The data may include an output voltage from the DC/DC pre-charger 58, a pre-charging runtime, an estimated completion time for discharging or pre-charging, a DC bus bar capacitance (calculated or estimated), faults detected during the pre-charging or discharging, and/or the like. The DC/DC pre-charger 58 may monitor the data during operation.

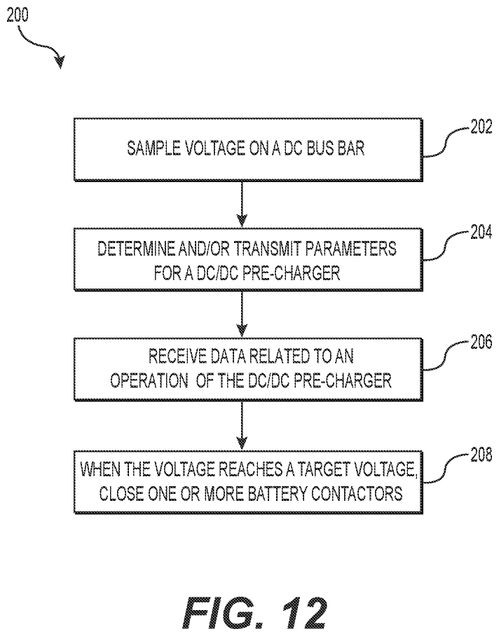

FIG. 12 illustrates an exemplary method 200 of controlling pre-charge operations of a DC/DC pre-charger 58 using an ESM system 26, according to the present disclosure. Although the method 200 is described as being performed by the ESM system 26, in some embodiments the BMS 30 and/or one or more controllers associated with the battery system 14 may perform the method 200 (or portions of the method 200). In some implementations, a combination of the ESM system 26, the BMS 30, and/or the one or more controllers may perform the method 200. For example, the ESM system 26 may perform the operations illustrated at 202 and 204, the BMS 30 may perform the operations illustrated at 206, and a controller may perform the operations illustrated at 208.

As illustrated at 202, the method 200 may include sampling a voltage on a DC bus bar 77. For example, the ESM system 26 may provide an instruction to the DC/DC pre-charger 58 to provide voltage samples to the ESM 26 and/or the ESM system 26 may sample the voltage directly from the DC bus bar 77. The voltage may be sampled using a sensor, a voltage probe, and/or the like.

The method 200 may further include, at 204, determining and/or transmitting parameters for a DC/DC pre-charger 58. For example, the ESM system 26 may determine the parameters when the ESM system 26 boots up, based on whether the DC/DC pre-charger 50 is to discharge or pre-charge the DC bus bar 77, and/or the like. The ESM system 26 may transmit the parameters to the DC/DC pre-charger 58 via the software communication lines 68. Additionally, or alternatively, the ESM system 26 may transmit the parameters upon booting up, at a scheduled time for pre-charging or discharging, and/or the like.

As illustrated at 206, the method 200 may include receiving data related to an operation of the DC/DC pre-charger 58. For example, the ESM system 26 may receive the data from the DC/DC pre-charger 58 via the software communication lines 68. The ESM system 26 may receive the data in a manner similar to that described above in connection with step 106 of the method 100 of FIG. 11. Additionally, or alternatively, the ESM system 26 may store the data in memory after receiving the data and/or may provide the data to a system external to the bus 10, such as when the bus 10 is connected to an external diagnostic system. Additionally, or alternatively, the ESM system 26 may process the data after receiving the data. For example, the ESM system 26 may filter the data, identify faults in operation of the DC/Dc pre-charger 58, aggregate the data with data from one or more other DC/DC pre-chargers 58, aggregate the data with historical data for the DC/DC pre-charger 58 and/or the like.

When the voltage reaches a target voltage, the method 200 may include, at 208, closing one or more battery contactors 72. For example, the ESM 26 may close the battery pack contactors 72 such that current flows from a battery module 34 to the HV bus bar 50. In some embodiments, the ESM system 26 may provide an instruction to the DC/DC pre-charger 58 to close the battery pack contactors 72. In some embodiments, the ESM system 26 may configure the DC/DC pre-charger 58 to close the battery pack contactors 72 when the target voltage is reached.

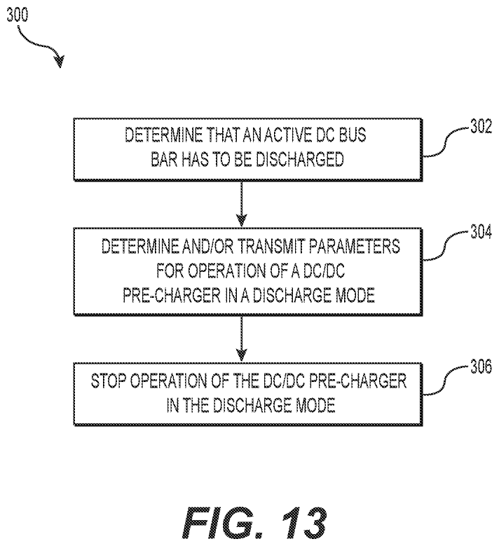

FIG. 13 illustrates an exemplary method 300 of controlling discharge operations of a DC/DC pre-charger 58 using an ESM system 26, according to the present disclosure. Although the method 300 is described as being performed by the ESM system 26, in some embodiments the BMS 30 and/or one or more controllers associated with the battery system 14 may perform the method 300 (or portions of the method 300). In some implementations, a combination of the ESM system 26, the BMS 30, and/or the one or more controllers may perform the method 300. For example, the ESM system 26 may perform the operations illustrated at 302, the BMS 30 may perform the operations illustrated at 304, and a controller may perform the operations illustrated at 306.

As illustrated at 302, the method 300 may include determining that an active DC bus bar 77 has to be discharged. For example, the ESM system 26 may determine that the DC bus bar 77 has to be discharged when an engine of the bus 10 is powered off. At the start of the method 300, the battery pack contactors 72 may be in an open state.

As illustrated at 304, the method 300 may include determining and/or transmitting parameters for operation of a DC/DC pre-charger 58 in a discharge mode. For example, the ESM system 26 may determine and/or transmit parameters in a manner similar to that described above in connection with the operation at 204 of the method 200 of FIG. 12. A parameter for discharge operations may be similar to the parameters described elsewhere herein or may include other parameters specific for discharging, such as a safe threshold voltage as a secondary target (e.g., a fast discharge may be used for the system voltage down to 50V, but then a slower discharge may be used for voltages lower than 50V).

The discharge mode may include a mode of operation of the DC/DC pre-charger 58 where the DC/DC pre-charger 58 discharges energy from the HV bus bar 50. As illustrated at 306, the method 300 may include stopping operation of the DC/DC pre-charger 58 in the discharger mode. For example, when the HV bus bar 50 is discharged (or discharged below a certain level), the ESM system 26 may transmit an instruction to the DC/DC pre-charger 58 to stop the operation. Additionally, or alternatively, the ESM system 26 may configure the DC/DC pre-charger 58 to stop the operation automatically when the HV bus bar 50 is discharged.

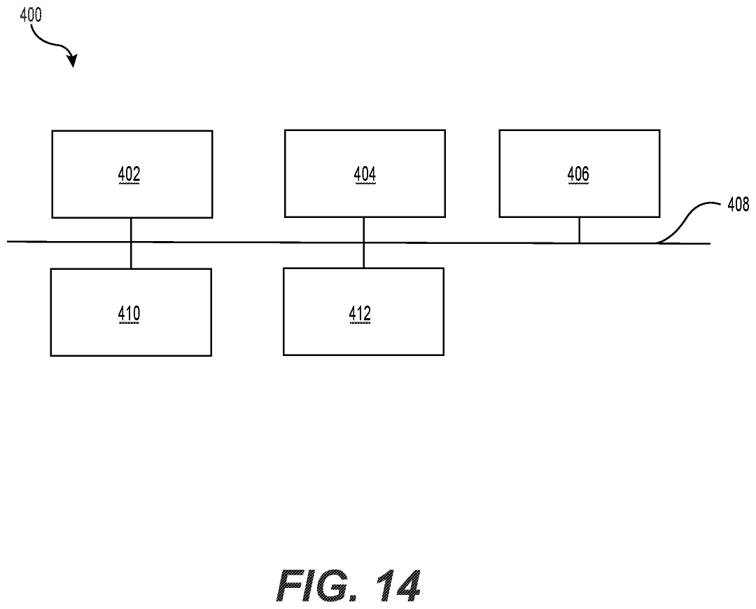

FIG. 14 illustrates example components of a computing device 400, according to the present disclosure. In particular, FIG. 14 is a simplified functional block diagram of a computing device 400 that may be configured as a device for executing methods of this disclosure, such as FIGS. 11, 12, and 13. For example, the computing device may be configured as the ESM system 26, the BMS 30, a battery pack controller, the high voltage peripheral device or system 52, the low voltage peripheral device or system 56, and/or another device or system according to exemplary embodiments of the present disclosure. In various embodiments, any of the devices or systems described herein may be the computing device 400 illustrated in FIG. 14 and/or may include one or more of the computing devices 400.

As illustrated in FIG. 14, the computing device 400 may include a processor 402, a memory 404, an output component 406, a communication bus 408, an input component 410, and a communication interface 412. The processor 402 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the processor 402 includes one or more processors capable of being programmed to perform a function. The memory 404 may include a random access memory (RAM), a read only memory (ROM), and/or another type of dynamic or static storage device (e.g., a flash memory, a magnetic memory, and/or an optical memory) that stores information and/or instructions for use by the processor 402.

The output component 406 may include a component that provides output information from the computing device 400 (e.g., a display, a speaker, and/or one or more light-emitting diodes (LEDs)). The communication bus 408 may include a component that permits communication among the components of the computing device 400. The input component 410 may include a component that permits the computing device 400 to receive information, such as via user input (e.g., a touch screen display, a keyboard, a keypad, a mouse, a button, a switch, and/or a microphone). Additionally, or alternatively, the input component 410 may include a sensor for sensing information (e.g., a global positioning system (GPS) component, an accelerometer, a gyroscope, and/or an actuator). The communication interface 412 may include a transceiver-like component (e.g., a transceiver and/or a separate receiver and transmitter) that activates device 400 to communicate with other devices, such as via a wired connection, a wireless connection, or a combination of wired and wireless connections. The communication interface 412 may permit the computing device 400 to receive information from another device and/or provide information to another device. For example, the communication interface 412 may include a controller area network (CAN) bus, an Ethernet interface, an optical interface, a coaxial interface, an infrared interface, a radio frequency (RF) interface, a universal serial bus (USB) interface, a wireless local area network interface, a cellular network interface, and/or the like.

As noted above, the computing device 400 illustrated in FIG. 14 may perform one or more processes described herein. The computing device 400 may perform these processes based on the processor 402 executing software instructions stored by a non-transitory computer-readable medium, such as the memory 404 and/or another storage component. For example, the storage component may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. A computer-readable medium is defined herein as a non-transitory memory device. A memory device includes memory space within a single physical storage device or memory space spread across multiple physical storage devices.

Software instructions may be read into the memory 404 and/or a storage component from another computer-readable medium or from another device via the communication interface 412. When executed, software instructions stored in the memory 404 and/or the storage component may cause the processor 402 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

Certain embodiments described herein may provide various technological advantages or improvements. For instance, certain embodiments described herein may facilitate safe closure of battery pack contactors without a significant inrush of current into a battery pack, which may reduce or eliminate damage to components of an electric vehicle that might otherwise occur due to an inrush of current. Additionally, or alternatively, by utilizing a DC/DC pre-charger in each battery pack of a battery system, certain embodiments may still provide for failover of pre-charging or discharging of a HV bus bar 50 from one DC/DC pre-charger to another, which may improve safety and reduce damage to electrical components in the event of a failure of a battery pack. Additionally, or alternatively, certain embodiments may provide a safety mechanism to discharge a HV bus bar in an accelerated but controlled manner (e.g., in the case of a failure of an HV device's internal discharge circuit). In this scenario, one or more DC/DC pre-chargers may be used to reduce the voltage on the HV bus bar to an acceptable and safe level. This may also be used if a more rapid than normal reduction in the DC voltage is needed, such as in the event of an emergency. Additionally, or alternatively, certain embodiments may facilitate faster identification of faults in pre-charging or discharging, such as through in-battery pack monitoring.

Additionally, or alternatively, certain embodiments described above include the BMS 30 and/or the ESM system 26 controlling the pre-charging or discharging. Having the BMS 30 control certain operations may facilitate operation of the battery pack 20 in a standalone manner. For example, each battery pack 20 may be controlled independently from other battery packs 20, which may simplify control by reducing or eliminating the need for battery packs 20 to be in communication with a central controller. Having the ESM system 26 control certain operations may facilitate better coordination of operations among multiple battery packs 20 (e.g., for tandem operations, reading faults or statuses, setting limits, etc.).

Additionally, or alternatively, certain embodiments may provide for selective enabling of high voltage circuits, either for partial operation, low power operation of certain components, or for recovery in the event of a non-powertrain failure. Additionally, or alternatively, certain control aspects described herein may provide for improved management of a battery system 14 compared to passive pre-charging circuits.

While principles of the present disclosure are described herein with reference to a battery pack that includes a DC/DC pre-charger for electric buses, it should be understood that the disclosure is not limited thereto. Rather, the systems and methods described herein may be employed in any type of electric vehicle. Also, those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description. For example, while certain features have been described in connection with various embodiments, it is to be understood that any feature described in conjunction with any embodiment disclosed herein may be used with any other embodiment disclosed herein.

We claim:

1. A battery system, comprising:
at least one battery pack comprising:
a direct current to direct current (DC/DC) pre-charger,
at least one battery cell,
a positive terminal and a negative terminal of the at least one battery cell electrically connected to a first positive bidirectional terminal and a first negative bidirectional terminal, respectively, associated with the DC/DC pre-charger, wherein the positive terminal and the negative terminal are electrically connected to a positive output terminal and a negative output terminal, respectively, of the at least one battery pack via at least one positive electrical connection and at least one negative electrical connection;
a high voltage bus bar electrically connected to the positive output terminal and the negative output terminal of the at least one battery pack; and
a communication bus bar electrically connected to the DC/DC pre-charger,
wherein the DC/DC pre-charger is configured to pre-charge the high voltage bus bar and/or discharge the high voltage bus bar via a second positive bidirectional terminal and a second negative bidirectional terminal.

2. The battery system of claim 1, wherein the at least one battery pack comprises at least one positive battery pack contactor and at least one negative battery pack contactor, and
wherein the at least one positive battery pack contactor and the at least one negative battery pack contactor are configured to electrically separate the positive and negative terminals of the at least one battery cell from the positive and negative output terminals, respectively.

3. The battery system of claim 2, wherein the second positive bidirectional terminal and the second negative bidirectional terminal of the DC/DC pre-charger are electrically connected to the at least one positive electrical connection between the at least one positive battery pack contactor and the positive output terminal of the at least one battery back, and
wherein the second negative bidirectional terminal of the DC/DC pre-charger is electrically connected to the at least one negative electrical connection between the at least one negative battery pack contactor and the negative output terminal of the at least one battery back.

4. The battery system of claim 1, wherein the second positive bidirectional terminal of the DC/DC pre-charger is electrically connected to a positive external bidirectional terminal, and
wherein the second negative bidirectional terminal of the DC/DC pre-charger is electrically connected to a negative external bidirectional terminal.

5. The battery system of claim 4, wherein the positive external bidirectional terminal and the negative external bidirectional terminal are electrically connected to the high voltage bus bar.

6. The battery system of claim 1, wherein a battery management system (BMS) within the at least one battery pack comprises a computing system configured to communicate with the DC/DC pre-charger via a communication bus bar.

7. The battery system of claim 1, wherein the first positive bidirectional terminal and the first negative bidirectional terminal are separately controllable from control of the DC/DC pre-charger.

8. The battery system of claim 1, wherein the computing system is configured to control the pre-charging or the discharging of the high voltage bus bar according to a set of parameters.

9. The battery system of claim 1, wherein the at least one battery pack comprises multiple battery packs electrically connected in series to form a string of battery packs.

10. The battery system of claim 9, wherein the battery system further comprises multiple strings of battery packs electrically connected in parallel, and
wherein DC/DC pre-chargers in each of the battery packs are configured to pre-charge or discharge at least a portion of a total string voltage.

11. A method of using a direct current to direct current (DC/DC) pre-charger located within a battery pack of a battery system, the DC/DC pre-charger being electrically connected to one or more battery cells of the battery pack, the method comprising:
receiving, by a computing system, a signal to control the DC/DC pre-charger;
controlling one or more battery pack contactors or the DC/DC pre-charger based on one or more parameters; and
receiving or reporting data associated with operation of the DC/DC pre-charger while controlling the one or more battery pack contactors and the DC/DC pre-charger.

12. The method of claim 11, wherein the controlling of the DC/DC pre-charger further comprises:
instructing the DC/DC pre-charger to power on;
configuring the DC/DC pre-charger to operate in a pre-charge mode; and
configuring a target voltage for a high voltage bus bar of the battery system.

13. The method of claim 11, wherein the data associated with the operation of the DC/DC pre-charger comprises at least one of:
a voltage on a DC bus bar of the battery system,
a runtime of the DC/DC pre-charger,
an estimated completion time of pre-charging,
a capacitance of the DC bus bar, or
faults that have occurred during the pre-charging.

14. The method of claim 11, wherein the controlling of the one or more battery pack contactors further comprises:
sending an instruction to the DC/DC pre-charger to close the one or more battery pack contactors once when a target voltage on a high voltage bus bar is reached.

15. The method of claim 11, wherein the computing system comprises a battery management system (BMS).

16. A method of using a direct current to direct current (DC/DC) pre-charger located within a battery pack of a battery system, the DC/DC pre-charger being electrically connected to one or more battery cells of the battery pack, the method comprising:
sampling, by a computer system, a voltage on a DC bus bar of the battery system;
generating or transmitting limits for an operation of the DC/DC pre-charger;
receiving data related to the operation of the DC/DC pre-charger; and
closing one or more battery contactors of the battery pack when the voltage reaches a target voltage.

17. The method of claim 16, wherein the computing system comprises an energy storage management (ESM) system.

18. The method of claim 16, wherein the sampling of the voltage further comprises:
receiving information indicating the voltage from the DC/DC pre-charger.

19. The method of claim 16, wherein the limits comprise a target voltage on the DC bus bar, a maximum output current for the battery pack, or a direction of the operation of the DC/DC pre-charger.

20. The method of claim 16, further comprising:
sending, in association with generating or transmitting the limits, an instruction to the DC/DC pre-charger to start pre-charging the DC bus bar;
monitoring the voltage on the DC bus bar; and
sending, after closing the one or more battery contactors, an instruction to the DC/DC pre-charger to stop pre-charging on the DC bus bar.
